(19) United States
(12) Patent Application Publication
(10) Pub. No.: US 2020/0074572 A1
(43) Pub. Date: Mar. 5, 2020

(54) Apparatus System and Method for Automated Power Revenue Optimization and Exchange System

(71) Applicant: Todd Romney, Sandy, UT (US)

(72) Inventor: Todd Romney, Sandy, UT (US)

(21) Appl. No.: 16/555,893

(22) Filed: Aug. 29, 2019

Related U.S. Application Data
(60) Provisional application No. 62/724,477, filed on Aug. 29, 2018.

(51) Int. Cl. G06Q 50/06; G06Q 40/04

(52) U.S. Cl. CPC G06Q 50/06; G06Q 40/04

(57) ABSTRACT

Provided herein are an apparatus, system, and method for optimization of power use, exchange, and revenue generation employing networks of small alternative and traditional power sources, specialized computer based modules and optionally cryptocurrency.

### CROSS-REFERENCES TO RELATED APPLICATIONS

This application claims priority to U.S. Provisional Patent Application No. 67/724,477 entitled “Apparatus, system, and method for automated power revenue optimization and exchange system” and filed on Aug. 29, 2018 for Todd Romney, which is incorporated herein by reference.

### FIELD OF THE INVENTION

This invention relates to electrical power grids and more particularly relates to electrical micro-grids and transfer of electrical power or other value including purchasing power between grids and the optimization thereof.

### BACKGROUND

### Description of the Related Art

Alternative power generation systems (APSs), such as wind, solar, hydro, tidal, biomass, and geothermal, continue to increase in efficiency such that the equivalent cost per kilowatt (C/kW) of power generated continues to go down. While early adopters of these alternative power generation systems primarily did so for non-economic reasons, for some of the technologies, the C/kW is approaching the commercial cost of electricity closely enough that economic drivers will begin to engage, and many more of these alternative power generation systems will be built and come on-line. This development may challenge the monopoly of single, centralized large-scale power plants. While there will continue to be a need for a large-scale power plant, and its associated distribution grid, in the future it may co-exist with many smaller, decentralized alternative power generation systems.

Each of these systems may have power generation and power consumption mismatches resulting in either an excess of power generated for the customer(s) they service, or a deficit of power needed for the customer(s) they service. This is currently the case even for large-scale power plants and continues to be a primary source of inefficiency within the current power generation and distribution business. Consequently, a need exists for an apparatus, system, and method enabling APSs to maximize the use, and the corresponding revenue received, for their own power generated, while minimizing the need for external power consumption, and when it is needed, minimize the cost of the power received from the external power provider.

### SUMMARY

From the foregoing discussion, it should be apparent that a need exists for an apparatus, system, and method to manage power distribution while optimizing efficient use and revenue. Beneficially, such an apparatus, system, and method would vastly improve the economic model for APSs, facilitating early economic viability and thereby hastening larger scale adoption. That larger scale adoption could predictably stimulate the number of producers, and potential sellers and purchasers of excess power generation.

The present invention has been developed in response to the present state of the art, and in particular, in response to the problems and needs in the art that have not yet been fully solved by currently available power distribution models. Accordingly, the present invention has been developed to provide an apparatus, system, and method for automated optimization of power use, revenue, and exchange that overcomes many or all of the above-discussed shortcomings in the art.

Provided herein is an apparatus, system, and method that enables a multitude of APSs to interact and more efficiently exchange and monetize power generation. Such a device and system could enable a network of APSs that are configured to produce and store electricity to transfer excess power across potentially large distances from one APS to another APS, or from one APS to a commercial power provider, or vice-versa, even when the two parties in the power exchange are not adjacent to each other, while still minimizing I²R losses and maximizing market dynamics for all of the parties involved in the transaction. Given the complexity and dynamic nature of the power grid, the network of APSs, and the power generation market itself, such a system may need to operate quickly, efficiently, and in an automated way, while at the same time maintaining enforceable, auditable contracts of the transactions across a potential multitude of parties involved in the power exchange contract.

In certain embodiments an apparatus to automatically optimize electrical power use, exchange and revenue, the apparatus comprises a computer based power price negotiating and contract recording module, one or more automated power exchange modules, a power optimization and exchange system interface module, a smart contract validation module,

a power metering module, a power control module, one or more power interconnect and transfer modules, a power storage module;
a data center module, and a computer based power source network power monitoring device. The various modules may communicate with each other via an Ethernet, Internet, or other wired or wireless type link. various of the modules are sometimes one or more physical device. The apparatus may further comprise at least one of shielding, automated ground interrupts, and other elements protective against a solar mass corona ejection event, and other natural and man-made electromagnetic pulses.

Also provided herein is a system for automatic optimization of power use transfer and revenue which comprises;

multiple power sources in separate service areas interconnected to form a power source network, a data center module,
a power metering module at the demarcation point between power grids, a power optimization and control module, a power storage module, a computer based power price negotiating and contract recording module, one or more automated power exchange modules, and a computer based power system network monitoring module. The power sources may be alternative power sources, traditional power sources or a mixture and the power source service areas may be overlapping, non-overlapping, adjacent or non-adjacent. The power sources are sometimes connected to the power metering modules and/or the power optimization and control module via a computer network connection or Internet connection. In some embodiments the power sources are connected to each other via a computer network connection or Internet connection and may communicate and interact with each other directly via the network, Internet or other remote connection.

In certain embodiments the computer based power system network monitoring module evaluates one or more of digital currency markets, energy markets accessible to the power source network, data services contracts to which the power source network is the provider, and the power source network's own power generation commitments, and directs the power from the various power sources comprising the network to be utilized in the manner that will maximize the revenue to the power source network as a whole. The automated power selling, purchasing, and power exchange contracts may be executed and recorded automatically between two or more parties involved in a power sale, purchase, or exchange contract. Power may be captured and stored in the power storage module when the price is relatively low for sale when the price is higher.

Further provided herein is a method for automated optimization of power use, revenue, and exchange, comprising the steps of; providing a network of power sources, providing a power optimization and control module, providing a data center module, calculating and implementing the optimization of power use, revenue, and exchange, tracking excess power production, negotiating for a transfer of power or resources, and profitably exploiting excess production. Smart contract based technology is sometimes utilized to establish a monetary like exchange across the network of power sources. A fiat power currency may be utilized with digital coin representing a certain amount of power generation such as 1 kWh-1 kWcoin or kWc. The kWc may be constantly created and retired as power is both generated and consumed. The kWc is sometimes recycled by issuing kWc to the power source selling the power and after sale by that power sources becomes available again to be reissued by the system to a power source selling power.

In various embodiments the kWc is created by the power optimization and control module, or other element and the smart contract is validated by a module for validating and maintaining the smart contract and the buy-sell transactions are recorded. The smart contract based technology sometimes utilizes block-chain technology. The kWc may be created by the power optimization and control module, or other element and the block-chain transaction may be validated by a module for validating and maintaining the block-chain and the buy-sell transactions are recorded.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 depicts an embodiment of a representative alternative power generation system (APS) in accordance with the present invention;

FIG. 2 depicts an embodiment of multiple APSs in geographically separated service areas interconnected to form a network of APSs (the APS Network) in accordance with the present invention;

FIG. 3 depicts an embodiment of the elements of a non-limiting representative Automated Optimization of Power, Use, and Exchange System (PROES); and

FIG. 4 is a schematic flow diagram depicting an embodiment of a method for automated optimization of power, use, revenue, and exchange.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

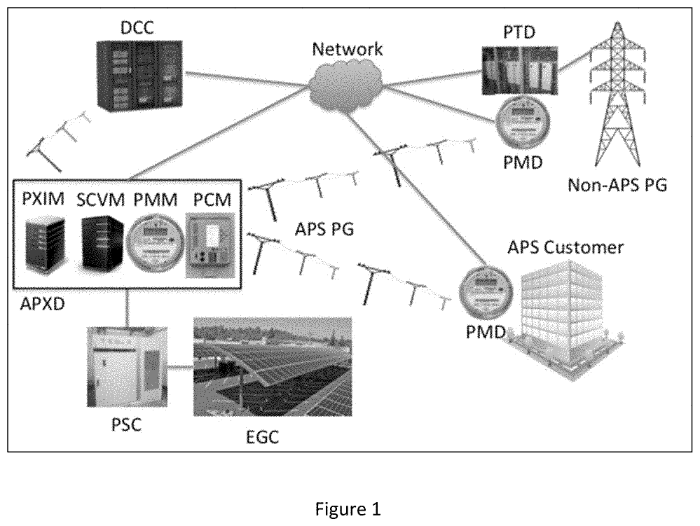

FIG. 1 depicts an embodiment of representative alternative power generation system 100 (APS) comprising an electricity generation component 102 (EGC), such as, but not limited to, solar, wind, hydro, biomass, tidal, or geothermal based generator, an optional power storage component 104 (PSC), power distribution components within the APS 100, one or more automated power exchange devices 106 (APXD), an optional data center component 108 (DCC), an interface with an external power distribution grid (the line of demarcation), power interconnect and transfer devices 110 (PTDs) at the line of demarcation between one APS power grid 112 (APS PG) and a non-APS power grid 114 (non-APS PG), power metering devices 116 (PMDs), and users (customers) 118 of the electricity generated by the APS 100. In certain embodiments, all the users are connected directly to the APS 100. Some users 118 may be connected directly to the APS 100, and other users 118 may be connected to the APS 100 via an external power grid not owned or operated by the APS 100. In some embodiments each of the APS 100's customers 118 have at least some electricity generation components and some optional power storage components on or adjacent to the customer 118's premise. In another embodiment of the invention, some of the APS 100's customers 118 have some electricity generation components and some optional power storage components on or adjacent to the customer 118's premise, while other customers 118 do not.

In some embodiments none of the APS 100's customers 118 have electricity generation components but do have some optional power storage components on or adjacent to the customer 118's premise. Sometimes none of the APS 100's customers 118 have electricity generation components or some optional power storage components on or adjacent to the customer 118's premise. The electricity generation components and some optional power storage components may be distributed throughout the APS 100 service area and may be connected via an external power distribution grid. In certain embodiments the electricity generation components and some optional power storage components are all adjacent to each other and connected to each other via APS 100 system power grid distribution components. The APS 100's electricity generation component and the optional power storage component are sometimes in a single location. The APS 100's electricity generation component may be in a single location, while the optional power storage component may be distributed throughout the APS 100's service area.

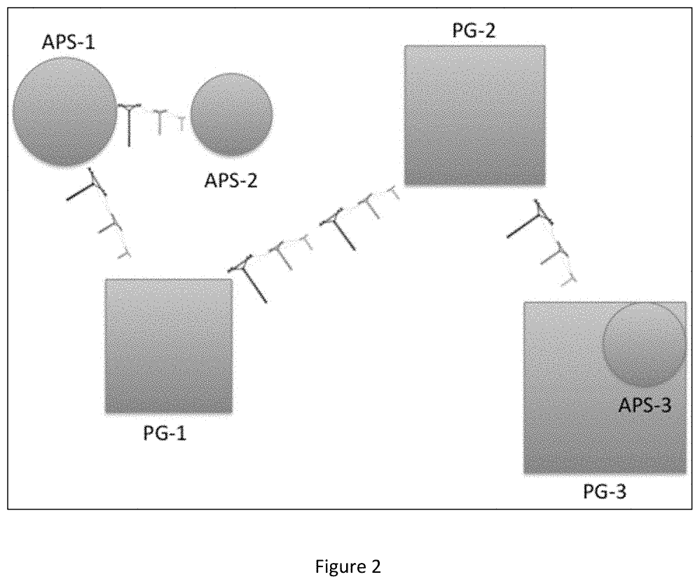

FIG. 2 depicts an embodiment of multiple APS 100s in geographically separated service areas interconnected to form a network of APSs (the APS Network) 200 comprising the multiple APS-1 202, APS-2 204, APS-3 206, etc., and comprising one or more non-APS power grids 114, PG-1 208, PG-2 210, PG-3, 212 etc., and power metering devices 214 at the demarcation points between each power grid (both APS power grids 112, and non-APS power grids 114). In some embodiments the APS 100 service areas are non-overlapping. In various embodiments the APS 100 service areas are overlapping. The APS 100 service areas are sometimes a mix of some overlapping and some non-overlapping. The APS 100s may be adjacent and connected to each other or may be not adjacent to each other and connected via other non-APS power grid(s) 114. The APS 100s are sometimes a mixture of some that are adjacent and connected to each other and some that are non-adjacent and connected via other non-APS power grid(s) 114. In certain embodiments, the power metering, and/or power exchange, and/or power control components 216 of all the APS 100s are controlled by a centralized power optimization and control system (the Power Exchange System, or PROES) 300 connected to the power metering and control components 216 of the APSs via a computer network connection or Internet connection 218. In various embodiments the power metering, and/or power exchange, and/or power control components 216 of all the APS 100s are not controlled by a centralized system but are connected to each other via a computer network connection or Internet connection 218 and may communicate and interact with each other directly via the network, Internet or other remote connection 218.

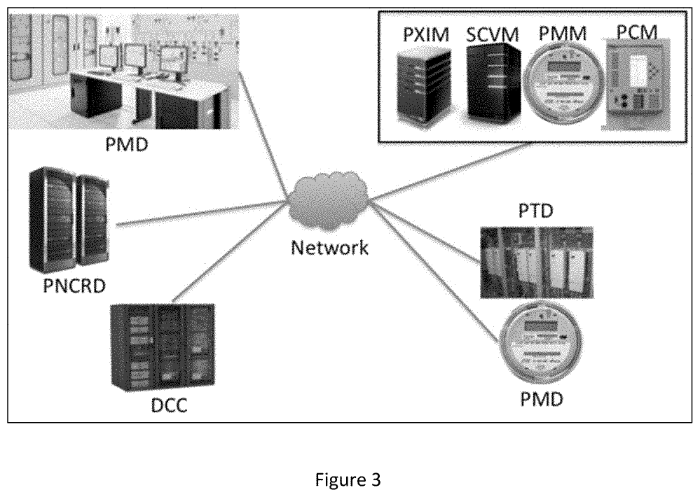

FIG. 3 depicts the elements of an embodiment of a Power Revenue Optimization and Exchange System (PROES) 300 comprising a computer based power price negotiating and contract recording device (PNCRD) 302; one or multiple automated power exchange devices (APXD) 304 comprising: 1) a Power Optimization and Exchange System interface module (PXIM) 306; 2) a smart contract validation module (SCVM) 308, 3) a power metering module (PMM) 310, and 4) a power control module (PCM) 312; one or more power metering devices (PMD) 314; one or more power interconnect and transfer devices (PTD) 316; a power storage component (PSC) 317; an optional plurality of data center components (DCC) 318; and a computer based APS network power monitoring device (PMD) 320. The various components are able to communicate with each other via an Ethernet, Internet, or other remote link (wired or wireless type link) 218. In some embodiments the modules comprising the APXD 304 are one physical device, while in various embodiments the modules comprising the APXD 304 are contained in two or more physical devices to facilitate the most efficient configuration and operation of the APXD 304. In certain embodiments the APXD 304 and other PROES 300 devices include without limitation shielding, automated ground interrupts, and other special design considerations to protect the PROES 300 and APXD 304 against a solar mass corona ejection event, and other natural and man-made electromagnetic pulses. Each APS power grid 112 and non-APS 114 power grid participating in the APS power network 200 may have an APXD 304 and PNCRD 302, which may be linked to the other APXD 304 and PNCRD 302s of each APS power grids 112 and non-APS power grids 114 in the APS power network 200, and also may be linked with an APS network PMD 302. In certain embodiments each APS power grid 112 and non-APS power grid 114 participating in the APS power network 200 does not have its own PNCRD 302, but does have its own APXD 304 which is connected to a single centralized PNCRD 302, and all of its power generating and power metering devices are linked to its APXD 304, which is also linked to the APS network PMD 320. In some embodiments, each APS power grid 112 and non-APS power grid 114 participating in the APS power network 200 does not have its own PNCRD 302 or APXD 304, but rather all of its power generating and power metering devices are linked to a single PNCRD 302, and also linked to the APS network PMD 320. The APS Network 200 and its associated PROES 300 is sometimes a mixture of the above different configurations.

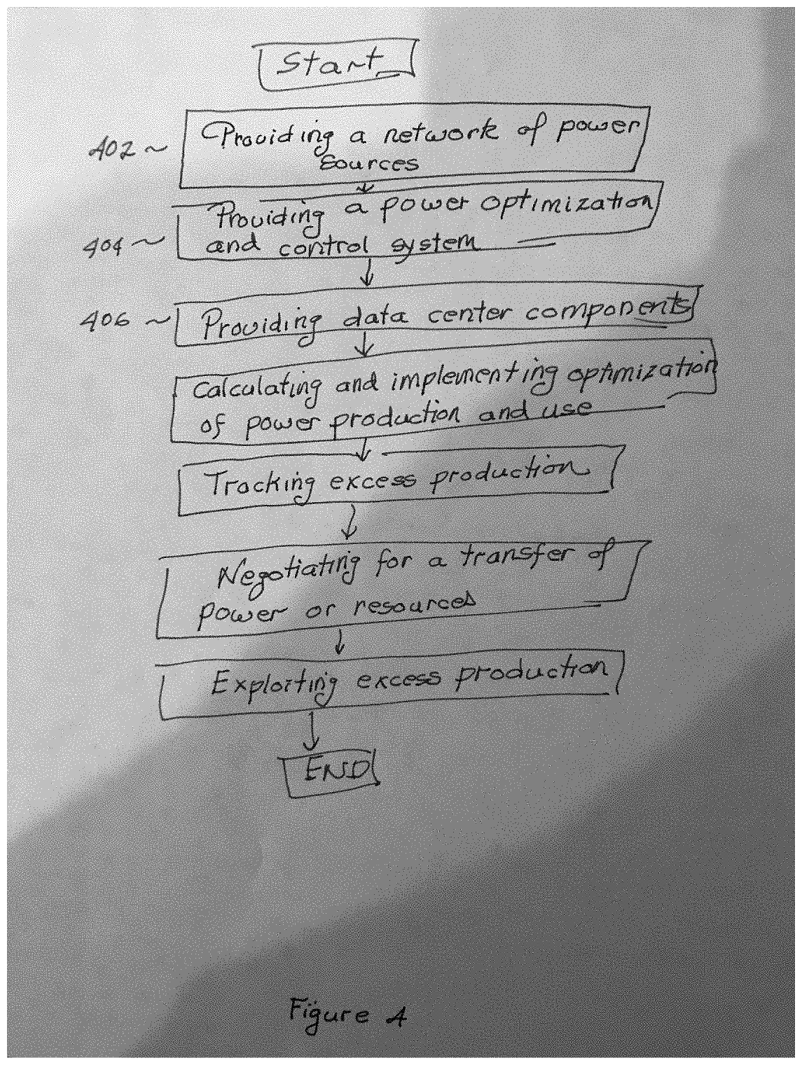

FIG. 4 is a schematic flow chart diagram depicting a method 400 for automated optimization of power use, revenue and exchange comprising the steps of providing 402 a network of power sources, providing 404 a power optimization and control system, providing 406 data center components, calculating and implementing 408 the optimization of power production and use, tracking 410 excess production, negotiating 406 for a transfer of power or resources, and exploiting 412 excess production as detailed below.

In an embodiment of a power exchange transaction between adjacent APSs 100 where APS-2 204 desires to purchase power generation or stored power from APS-202, APS-1 202 and APS-2 204 use the APXD 304s and PNCRD 302(s) to agree on the sale price of the power. APS-2 204 agrees to purchase a certain amount of power (kWh) from APS-1 202. The contract agreed to between APS-1202 and APS-2 204 may be done in advance or may be done in near real time. The contract may be a one-time contract for a set amount of power to be transferred from APS-1 202 to APS-2 204 over a set amount of time, with or without an expiration time for the contract before which the power must be transferred, or the contract may be for a recurring transfer to occur when certain pre-conditions are met. In certain embodiments once the contract is executed between the parties, and the conditions of the contract are met, the APXD 304 validates the contract, and allows the power to be transferred across the demarcation point between APS-1 202 and APS-2 204, and the APXD 304s record the amount of power flowing from one power grid to the other. When the transferred power reaches the amount purchased, or the conditions stipulated in the contract have been satisfied or are no longer met, the APXD 304 stops the transfer of power, and the PNCRD 302(s) records the transaction as having been partially fulfilled and completed, or fully fulfilled and completed as the case may be.

In a similar fashion, a power exchange transaction could be agreed to between an APS power grid 112 and a non-APS power grid 114. Multi-party transactions are also able to be quickly and seamlessly transacted, enabling the effective transfer of power from non-adjacent areas of the APS Network 200, thereby minimizing I²R losses by setting up a cascading chain of power transfers. The intermediary power grids may gain some power in the transaction, sell some power in the transaction, or the net gain in power by intermediary grids may be near zero. For example, PG-3 212 may wish to purchase power at a price that AS-1 202 is willing to sell it at, but in order for power to get from AS-1 202 to PG-3 212 it must traverse PG-1 208 and PG-2 210. In this instance AS-1 202 may sell the power to PG-1 208 , who in turn sells it to PG-2 210, who in turn sells it to PG-3 212 at a price PG-3 212 agrees to pay for the power.

The PROES 300 may be configured to provide each seller in the chain with a slight margin either in the form of an additional amount of energy that remains in the intermediary grid, in the form of a currency or credit, or it may be configured so that each participant in the ASP Network 200 that can buy or sell the digital currency agrees to allow transactions to traverse its network provided that the net power gained or lost to its own power grid remains zero or a specified differential . In either case, the APXD 304s and PNCRD 302(s) still need to demonstrate to each power grid in the ASP Network 200 that the requisite amount of power entered and left the grid and provide an auditable semi-automated or automated bill or payment to each participant in the ASP Network 200.

The contract agreed to and executed between the parties may be of an automated, or semi-automated “smart contract” which in the preferred embodiment utilizes block-chain technology to securely record the smart contract. In various embodiments, the contract executed between the parties still has components of a smart contract but is not block-chain based. Block-chain technology is sometimes combined with other mathematical algorithms to create a tamper resistant system both in terms of preventing an unauthorized entity from taking control of the PROES 300 or changing the transaction records. An optional encryption module may be added to the APXD 304 in order to achieve the desired level of tamper resistance.

In various embodiments, block-chain based technology is utilized to establish a monetary like exchange across the APS grid 112 and non-APS grid 114 APS network 200. A fiat power currency may be utilized where each digital coin represents a certain amount of power generation (such as 1 kWh-kWcoin or kWc). The kWc is constantly created and retired by the PROES 300 as power is both generated and consumed via the executed contracts of the network 200. In some embodiments, the kWc is recycled by the PROES 300 by issuing kWc to the APS 100 selling the power, who then sells the kWc to another party, and once the contract has been fulfilled then that kWc becomes available again to be reissued by the system to an APS 100 selling the power. The kWc may be created by the PNCRD 302(s), the APXD 304(s), or a separate computer based device for creating the kWc. Transactions on the block-chain may be validated by the PNCRD 3032(s), the APXD 304(s), or a separate computer based device for validating and maintaining the block-chain. The PNCRD 302(s) and APXD 304s may react in near real-time to optimally match buy and sell orders for the fiat digital currency, with the buy-sell transactions being recorded in the block-chain, as well as the partial fulfillment, complete fulfillment, and completion of those transactions. In this manner, the available power resources of the APS Network 200 as a whole may be directed to the highest bidder, and then subsequently lower bidders, as available power resources are available for distribution to PG 208+s and other APS 100s. In various embodiments the PROES 300 constantly evaluates the inputs from the APS Network 200 to maximize the aggregate revenue to the APS Network 200, while at the same time minimizing the power cost to the APS 100s within the APS Network 200. It does this by facilitating transactions for low cost transfers of power from one APS 100 to another APSs 100 within the APS Network 200, while maximizing the revenue for power transfers from APS 100s within the APS Network 200 to non-APS power grids 214 within the APS Network 200. The PROES 300 also functions to create viable lower-cost power source redundancies to the APS 100s within the APS Network 200 in order to reduce the reliance on higher cost power grid sourced alternatives.

The optional PROES 300 controlled PSC 317s within the APS 100s provide the PROES 300 with the ability to better ensure all power generated by APS 100 is captured and utilized. It also enables the PROES 300 to capture and store power in the PSC 317s when the C/kWh is relatively low, and then sell the power when the C/kWh is higher. Even if excess power from the APS 100s within the APS Network 200 is insufficient to fill the PSC 318s, the PROES 300 is able to purchase power from PG 208+s when the C/kWh is relatively low, and then resell the power to the PG 208+ when the C/kWh is higher, thereby maximizing the revenue generated from the PSC 317s. The PROES 300 may be utilized to source the lowest C/kWh for the power going into the PSC 317s—even from distant geographic locations—as well as maximize the revenue for the power in the PSC 317s when selling it to others or minimizing the power cost for an APS 100 with a power deficit as the case may be.

In various embodiments the optional plurality of PROES 300 controlled DCC 318s distributed throughout some or all of the APS 100s in the APS network 200 serve as an additional means through which the PROES 300 is able to maximize the revenue received for the power generated by the network of APS 100s. Utilizing its data center efficiency optimization algorithm, combined with virtual machine and virtual server technology, the PROES 300 adjusts the aggregate load of all of the APS 100 DCC 318s to run on the DCC 318s where the local C/kWh rate is the lowest, shifting it as the local C/kWh shifts to always maintain the lowest C/kWh while also factoring in other data center customer requirements, as well as the data center resource and power resource constraints. For DCC 318s that have excess data center resources available, the PROES 300 evaluates the current APS network 200 market rate for kWc against the current market rate for data mining services.

Provided the amount of revenue the excess data resources could bring in if engaged in the data mining services is higher than the revenue that could be obtained through selling the excess APS network 200 power to PG 208+s (or higher than the cost of purchasing the power from the PG 208+s), the PROES 300 may direct the excess data center resource capacity to engage in the data mining services. Concurrently the PROES 300 may use the smart contract methods described above to ensure all different APS 100s in the APS network 200 that are parties to the shifting of power and or data center resources are properly compensated for their relative contributions of power and data center capacity.

The APS 100s may be owned or partly owned by different individuals or entities. The individual or entities may have developed property that serves as the anchor customer for the power the APS 100 produces and may also serve to provide some or all of the geographic area the ECG 102 requires, such as parking lot areas, roof top areas, or previously undeveloped property areas. In addition to providing power to the tenants of the property of the APS 100 owner, the owner may also install electric vehicle charging stations on the property as an additional means of maximizing the APS 100's revenue. In certain embodiments the APS 100 pays a franchise fee to the entity that operates the PROES 300, in exchange for the PROES 300 monitoring the APS 100 and optimizing the revenue the APS 100 receives for its power utilizing the apparatus, methods, and systems described above. The fee the APS 100 pays to the PROES 300 may be monetary, or it may be in kWc, which the PROES 300 then may redeem from the APS for power at a later date, which the PROES 300 may then resell to some other business entity or individual utilizing the power exchange system described above. In some embodiments the PROES 300 sells the kWc to some other business entity or individual, who is then able to redeem the kWc from the APS 100 or the PROES 300 at a later date.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to automatically optimize electrical power use, exchange and revenue, the apparatus comprising a computer based power price negotiating and contract recording module;
one or more automated power exchange modules;
a power optimization and exchange system interface module;
a smart contract validation module;
a power metering module;
a power control module;
one or more power interconnect and transfer modules;
a power storage module;
a data center module; and
a computer based power source network power monitoring device.

2. The apparatus of claim 1, wherein various modules are able to communicate with each other via an Ethernet, Internet, or other wired or wireless type link.

3. The apparatus of claim 1, wherein various of the modules are one or more physical device.

4. The apparatus of claim 1 further comprising at least one of shielding, automated ground interrupts, and other elements protective against a solar mass corona ejection event, and other natural and man-made electromagnetic pulses.

5. A system for automatic optimization of power use transfer and revenue, the system comprising:
multiple power sources in separate service areas interconnected to form a power source network;
a data center module;
a power metering module at the demarcation point between power grids;
a power optimization and control module;
a power storage module;
a computer based power price negotiating and contract recording module;
one or more automated power exchange modules; and
a computer based power system network monitoring module.

6. The system of claim 5 wherein the power sources are at least one of alternative power sources, traditional power sources or a mixture.

7. The system of claim 6 wherein the power source service areas are at least one of overlapping or non-overlapping and adjacent or non-adjacent.

8. The system of claim 7 wherein the power sources are connected to the power metering modules and/or the power optimization and control module via a computer network connection or Internet connection.

9. The system of claim 7 wherein the power sources are connected to each other via a computer network connection or Internet connection and may communicate and interact with each other directly via the network, Internet or other remote connection.

10. The system of claim 5 wherein the computer based power system network monitoring module evaluates one or more of digital currency markets, energy markets accessible to the power source network, data services contracts to which the power source network is the provider, and the power source network's own power generation commitments, and directs the power from the various power sources comprising the network to be utilized in the manner that will maximize the revenue to the power source network as a whole.

11. The system of claim 5 wherein automated power selling, purchasing, and power exchange contracts are executed and recorded automatically between 2 or more parties involved in a power sale, purchase, or exchange contract.

12. The system of claim 5 wherein power is captured and stored in the power storage module when the price is relatively low, for sale when the price is higher.

13. A method for automated optimization of power use, revenue, and exchange, the method comprising the steps of:
providing a network of power sources;
providing a power optimization and control module;
providing a data center module;
calculating and implementing the optimization of power use, revenue, and exchange;
tracking excess power production;
negotiating for a transfer of power or resources; and
profitably exploiting excess production.

14. The method of claim 13, wherein smart contract based technology is utilized to establish a monetary like exchange across the network of power sources.

15. The method of claim 14 wherein a fiat power currency is utilized with digital coin representing a certain amount of power generation such as 1 kWh-1 kWcoin or kWc.

16. The method of claim 14 wherein the kWc is constantly created and retired as power is both generated and consumed.

17. The method of claim 15 wherein the kWc is recycled by issuing kWc to the power source selling the power and after sale by that power sources becomes available again to be reissued by the system to a power source selling power.

18. The method of claim 14 wherein the kWc is created by the power optimization and control module, or other element and the smart contract is validated by a module for validating and maintaining the smart contract and the buy-sell transactions are recorded.

19. The method of claim 14 wherein the smart contract based technology utilizes block-chain technology.

20. The method of claim 19 wherein the kWc is created by the power optimization and control module, or other element and the block-chain transaction is validated by a module for validating and maintaining the block-chain and the buy-sell transactions are recorded.
